(19) United States
(12) Patent Application Publication
(10) Pub. No.: US 2020/0047465 A1
(43) Pub. Date: Feb. 13, 2020

(54) INTELLIGENT TRANSMITTANCE CONTROL SYSTEM

(71) Applicant: SAINT-GOBAIN GLASS FRANCE, COURBEVOIE (FR)

(72) Inventor: Florian MANZ, Aachen (DE)

(21) Appl. No.: 16/603,055

(22) PCT Filed: Feb. 23, 2018
(86) PCT No.: PCT/EP2018/054544

§ 371 Date: Oct. 4, 2019

(30) Foreign Application Priority Data
Apr. 5, 2017 (EP) 17164885.0

(51) Int. Cl. B32B 17/10

(52) U.S. Cl. CPC B32B 17/10201; B32B 17/10192; B32B 17/10357

(57) ABSTRACT

An intelligent transmittance control system includes a multilayer film having electrically controllable fields, wherein the optical properties of the fields are influenced by the control, a controller, and a sensor, wherein the multilayer film includes first and second structured electrically conductive layers, wherein an electrically active layer is arranged between the first and second conductive layers, and wherein the structuring of the first electrically conductive layer has an angle of more than 0° relative to the structuring of the second electrically conductive layer. The controllable fields are created by overlapping the structures of the first and second conductive layers. The controller controls the strips of the first and second conductive layers as a function of the sensor such that the optical properties of one or a plurality of fields are selectively influenced.

The invention relates to an intelligent transmittance control system.

### BACKGROUND OF THE INVENTION

To protect against unwanted solar radiation, it is known to install shades in front of windows. These are also used in the motor vehicle sector in roof glazings. For this, for example, controllable surface elements are used, which partially or completely shade either the entire surface or lamella-like sub-regions. The term “lamella-like sub-regions” means that sub-regions are arranged on the roof glazings positioned one after another normal to the primary direction of travel.

Techniques for producing such glazings with shading are known, for example, from WO 96/24881 A1, EP 1 683 668 A2, WO 2014/072137 A1, and WO 2014/086555 A1.

It has, however, become clear that excessive shading has a very fatiguing effect on motor vehicle users since, now, with a change in the viewing direction, the eyes must compensate for a strong change in brightness from the vehicle surroundings into the vehicle interior. In addition, depending on physical conditions, the adaptation requires a different amount of time such that under certain circumstances the adaptation time is so great that relevant data cannot be registered in a timely manner.

In other words, although shading makes sense in principle, for example, to suppress the effects of glare through a roof glazing, too much shading is detrimental to safety.

### BRIEF DESCRIPTION OF THE INVENTION

The object is accomplished by an intelligent transmittance control system. The intelligent transmittance control system has a multilayer film having a plurality of electrically controllable fields, wherein the optical properties of the fields are influenced by the control, a controller, and at least one sensor, wherein the multilayer film has at least one first structured electrically conductive layer and one second structured electrically conductive layer, wherein an electrically active layer is arranged between the first structured electrically conductive layer and the second structured electrically conductive layer, wherein the structuring of the first electrically conductive layer has an angle of more than 0° relative to the structuring of the second electrically conductive layer, wherein a plurality of electrically controllable fields are created by overlapping the structures of the first electrically conductive layer and the structures of the second electrically conductive layer, wherein the controller controls one or a plurality of the strips of the first electrically conductive layer formed by structures and one or a plurality of the strips of the second electrically conductive layer formed by structures as a function of the sensor such that the optical properties of one or a plurality of fields are selectively influenced.

In one embodiment of the invention, the first structured electrically conductive layer and/or the second structured electrically conductive layer comprises indium tin oxide, ferroelectrics, cholesteric liquid crystal.

In another embodiment of the invention, the at least one sensor is selected from a group comprising a seat occupied sensor, a seat position sensor, a camera, a brightness sensor.

According to another embodiment of the invention, the system has at least one first and one second sensor, wherein the second sensor is selected from a group comprising a position sensor, a driving dynamics sensor. The position sensor is preferably a sensor for satellite-based navigation, for example, a GPS sensor or a position sensor with an electronic compass.

According to another embodiment of the invention, the structuring of the first electrically conductive layer has an angle of roughly 90° relative to the structuring of the second electrically conductive layer.

In another embodiment of the invention, the multilayer film is part of a composite glass pane.

In another embodiment of the invention, the system is used in vehicles or buildings. Preferably, the use is in a vehicle for transmittance control of a roof glazing.

### BRIEF DESCRIPTION OF THE DRAWINGS

Embodiments of the present invention are described by way of example with reference to the appended drawings, which depict:

FIG. 1 a first structured electrically conductive layer according to the invention,

FIG. 2 a second structured electrically conductive layer according to the invention,

FIG. 3 a basic layer structure of a multilayer film according to the invention or a composite glass pane according to the invention, and

FIG. 4 schematically, various embodiments of a system according to the invention.

### DETAILED DESCRIPTION OF THE INVENTION WITH REFERENCE TO THE DRAWINGS

In the following, the invention is presented in greater detail with reference to the figures. It should be noted that different aspects are described that can be used individually or in combination. In other words, any aspect can be used with different embodiments of the invention unless explicitly presented as a pure alternative.

Furthermore, for the sake of simplicity, usually only one entity is referenced in the following. Unless explicitly stated, the invention can include, however, in each case, a plurality of the entities concerned. Thus, the use of the words “a” and “an” is to be understood as an indication that at least one entity is used in a simple embodiment.

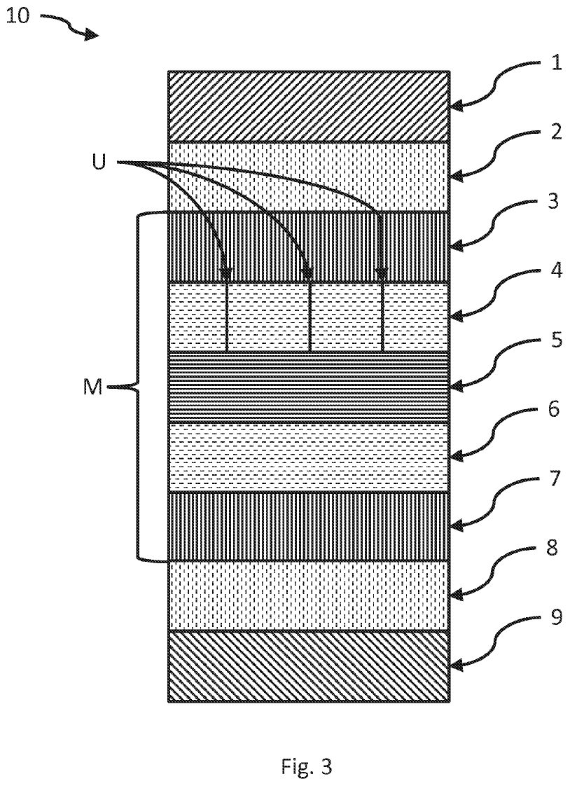

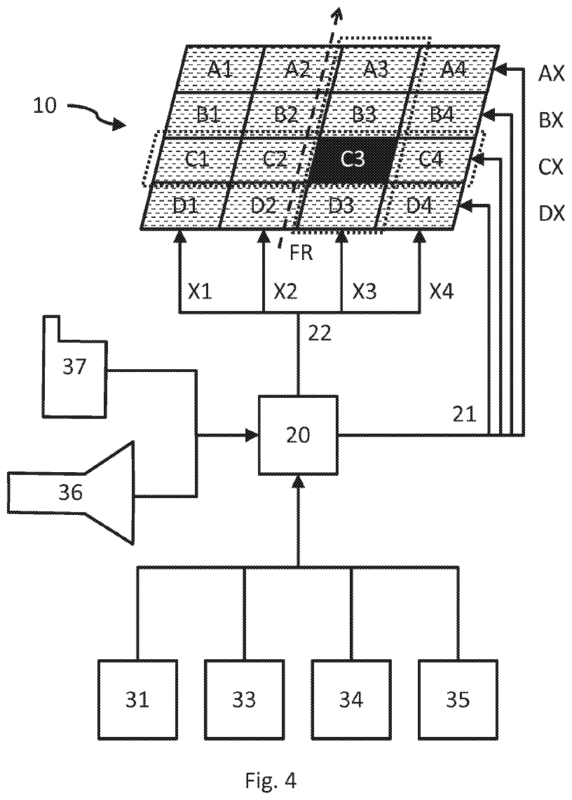

FIG. 4 depicts elements of an intelligent transmittance control system according to the embodiments of the invention.

The intelligent transmittance control system has a multilayer film M having a plurality of electrically controllable fields A1 . . . D4. The optical properties of the fields A1 . . . D4 can be selectively influenced by the control.

The intelligent transmittance control system also has a controller 20 and at least one sensor (31 . . . 36).

The multilayer film M, which can also be part of a glass pane, in particular a composite glass pane 10, has at least one first structured electrically conductive layer 4 and one second structured electrically conductive layer 6, wherein an electrically active layer 5 is arranged between the first structured electrically conductive layer 4 and the second structured electrically conductive layer 6.

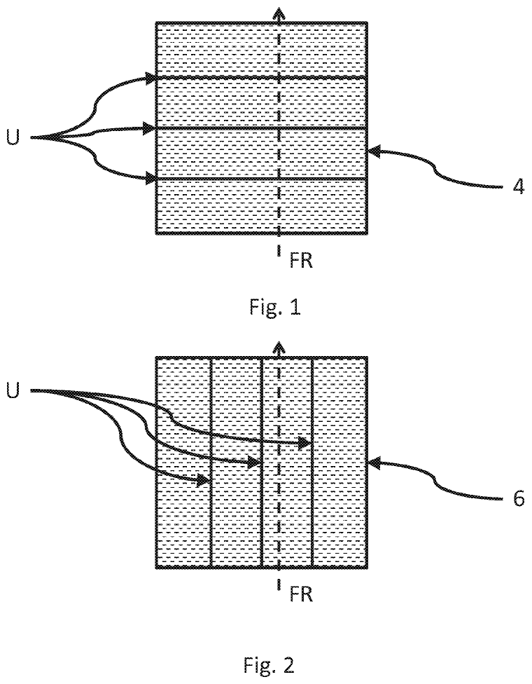

For example, the structuring is—as depicted in FIGS. 1 and 2—linear. This is, however, not absolutely necessary. Strips are created in the electrically conductive layer between the structures U or the structures and the edge. The structures U constitute an electrical separation. The structures U can be provided already at the time of preparation, in other words, at the time of application of the electrically conductive layers 4 or 6 or, however, alternatively or additionally, introduced subsequently during the course of a production process. For example, it would be possible to arrange individual strips of electrically conductive layers near each other or, however, to introduce them into an electrically conductive layer through surface treatment, such as scribing, cutting, or vaporizing.

The structuring U of the first electrically conductive layer 4 (see FIG. 1) has an angle of more than 0° relative to the structuring U of the second electrically conductive layer 6 (see FIG. 2). Here, it is assumed that there is a common (travel) direction FR represented by the dashed arrow.

By means of the resultant overlapping of the structures U of the first electrically conductive layer 4 and the structures U of the second electrically conductive layer 6, a plurality of electrically controllable fields A1 . . . D4 are created, as is discernible, for example, in FIG. 4.

The controller 20 controls, as a function of the one sensor 31 . . . 36 or of a plurality of sensors 31 . . . 36, one or a plurality of the strips of the first electrically conductive layer 4 formed by structures and one or a plurality of the strips of the second electrically conductive layer 6 formed by structures such that the optical properties of one or a plurality of fields A1 . . . D4 are selectively influenced. Here, “influence” can mean that the transmittance through the electrically active layer 5 is changed and/or that the reflectivity on the electrically active layer 5 is changed by application of an electrical voltage to the respective formed strip.

In FIG. 4, it is, for example, assumed that field C3 is controlled differently from the remaining fields via the x-control 21 and the y-control 22. Although, here, only a binary control in two states is depicted, the invention is not limited to this and more than two states can also be realized.

In FIG. 4, for example, field C3 is selected by choosing the surface electrode X3 of the y-control 22 and the surface electrode CX of the x-control 21, respectively.

In other words, it is now possible, with the help of the sensor 31 . . . 36 to determine which field or fields A1 . . . D4 are to be selectively influenced. Thus, for example, shading can be obtained selectively such that glare is avoided, whereas other regions are not shaded such that the brightness in the surrounding region approximates the ambient brightness. This ensures that fatigue phenomena as well as eye adaptation problems are avoided such that, for example, driving safety can be increased.

In one embodiment of the invention, the first structured electrically conductive layer 4 and/or the second structured electrically conductive layer 6 comprises indium tin oxide, ferroelectrics, cholesteric liquid crystal. As a result, shading can be achieved particularly easily. In addition, the degree of shading can be selectively varied by varying the electrical voltage.

In one embodiment of the invention, the active layer 5 contains liquid crystals that are, for example, embedded in a polymer matrix. Such active layers are known, for example, as PDLC layers. When no voltage is applied on the surface electrodes formed by the structure U, the liquid crystals are oriented in a disorderly manner, resulting in strong scattering of the light passing through the active layer 5. When a voltage is applied on the surface electrodes formed by the structure U, the liquid crystals orient themselves in one common direction and the transmittance of light through the active layer is increased. In particular, an alternating voltage can be applied on the surface electrodes.

In one embodiment of the invention, the at least one sensor 31 . . . 36 selected from a group comprising: a seat occupied sensor, a seat position sensor, a camera, an intensity (brightness) sensor.

For example, in a vehicle, a seat occupied sensor 32, as is, e.g., used for the airbag controller, can be used to detect which seats are occupied in a vehicle. Then, for example, one or a plurality of fields A1 . . . D4 that provide shading relative to the seat can be selectively controlled.

Alternatively, or additionally, a seat position sensor 32 or values of an electrical seat adjuster can also be used to determine the position. Then, for example, one or a plurality of fields A1 . . . D4 that provide shading relative to the seat can be selectively controlled.

Alternatively, or additionally, one (or a plurality of) camera(s) 36 can also be used to determine the position of individuals. Then, for example, one or a plurality of fields A1 . . . D4 that provide shading relative to the seat can be selectively controlled.

Alternatively, or additionally, one (or a plurality of) intensity sensor(s) 33 can also be used, for example, to monitor the interior of a vehicle globally or to monitor the ambient brightness overall, or, alternatively, or additionally, to determine the brightness conditions at specific positions. Here, already existing vehicle sensors, such as ambient brightness sensors, can be drawn on.

In one embodiment of the invention, the system has at least one first and one second sensor 31 . . . 36, with the second sensor selected from a group comprising a position sensor, a driving dynamics sensor.

In one embodiment of the invention, a position sensor 31, such as data of a GPS or a comparable satellite navigation device and/or an electric compass, can also be used to determine the position of the multilayer film M relative to solar radiation. Then, for example, one or a plurality of fields A1 . . . D4 that provide shading relative to a seat can be selectively controlled.

Alternatively, or additionally, a driving dynamics sensor, such as steering angle, inclinometer, driving speed, can also be used to determine the position of the multilayer film M relative to solar radiation. Then, for example, one or a plurality of fields A1 . . . D4 that provide shading relative to a seat can be selectively controlled.

It should be pointed out that the different sensors 31 . . . 36 can be readily linked into the controller 20 such that any conceivable lighting situation can be used for suitable control. Thus, for example, it can be determined globally by means of a seat occupied sensor 32 whether other sensors are to be evaluated all. If, for example, a seat is not occupied, further detection is usually unnecessary. However, if a seat is occupied, the seat height of a seat position controller 32 can be used, for example, as well as data from a camera 36, to indicate whether a tall person or a small person is situated relative to the individual fields A1 . . . D4 of the multilayer film M.

It should be noted that also one (or a plurality of) proximity sensor(s) can, alternatively, or additionally, be integrated in the multilayer film M or in a composite glass pane 10 or installed in suitable proximity. The position data relative to the multilayer film M can also be used, for example, to determine, from the angle of the sun relative to the surface of the multilayer film M and relative to the direction of travel FR, which fields A1 . . . D4 must be controlled.

A manual controller 37, e.g., via suitable operating devices and/or a wireless controller, for example, via a smartphone app, can also be easily provided to selectively control individual fields and/or to set parameters of the controller 20.

In one embodiment of the invention, the structure U of the first electrically conductive layer 4 has an angle of roughly 90° relative to the structure U of the second electrically conductive layer 6. Furthermore, the structures U related to one electrically conductive layer are preferably parallel to one another. Thus, it is particularly easy to produce uniform fields A1 . . . D4, making it possible, for example, to reduce the production costs for different markets (right-hand drive/left-hand drive).

In one embodiment of the invention, the multilayer film M is part of a composite glass pane 10. In addition to the electrically active layer 5, the electrically conductive layers 4 and 6, and the carrier layers 3 and 7, the multilayer film M can, of course, have other layers known per se, for example, barrier layers, blocking layers, antireflection or reflection layers, protective layers, and/or smoothing layers and/or electrically functional layers, e.g., for sensors.

An exemplary composite glass pane 10, which can, however, have even further functional layers (not shown), such as antireflection coating, thermal insulation, sensors, etc., is depicted in FIG. 3.

The composite glass pane 10 comprises, in the layer sequence from top to bottom, a glass pane 1, a thermoplastic connecting film 2, a carrier layer 3, an electrically conductive layer 4, an electrically active layer 5, an electrically conductive layer 6, a carrier layer 7, a thermoplastic connecting film 8, and a glass pane 9.

The thermoplastic connecting films 2 and 8 contain at least one material selected from the group comprising polybutylene terephthalate (PBT), polycarbonate (PC), polyethylene terephthalate (PET), and polyethylene naphthalate (PEN), polyvinyl chloride (PVC), polyvinyl fluoride (PVF), polyvinyl butyral (PVB), ethylene vinyl acetate (EVA), polyacrylate (PA), polymethyl methacrylate (PMMA), polyurethane (PUR), and/or mixtures and copolymers thereof.

The carrier layers 3 and 7 preferably contain at least one thermoplastic polymer, particularly preferably polyethylene terephthalate (PET). This is particularly advantageous in terms of the stability of the multilayer film. The carrier films can, however, also contain, for example, ethylene vinyl acetate (EVA) and/or polyvinyl butyral (PVB), polypropylene, polycarbonate, polymethyl methacrylate, polyacrylate, polyvinyl chloride, polyacetate resin, casting resins, acrylates, fluorinated ethylenepropylenes, polyvinyl fluoride, and/or ethylene tetrafluoroethylene. The thickness of each carrier layer 3 or 7 is preferably from 0.1 mm to 1 mm, particularly preferably from 0.1 mm to 0.2 mm.

The electrically conductive layers 4 and 6 are preferably transparent. The electrically conductive layers 4 and 6 preferably contain at least one metal, one metal alloy, or one transparent conducting oxide (TOO). The electrically conductive layers 4 and 6 preferably contain at least one transparent conducting oxide.

It has been demonstrated that electrically conductive layers 4 and 6 made of a transparent conducting oxide are particularly well suited for the laser processing according to the invention. The electrically conductive layers 4 and 6 particularly preferably contain at least indium tin oxide (ITO). The electrically conductive layers 4 or 6 can, however, also contain, for example, silver, gold, copper, nickel, chromium, tungsten, indium zinc oxide (IZO), cadmium stannate, zinc stannate, gallium-doped or aluminum-doped zinc oxide, or fluorine-doped or antimony-doped tin oxide.

The electrically conductive layers 4 and 6 preferably have a thickness of 10 nm to 2 μm, particularly preferably of 20 nm to 1 μm, most particularly preferably of 30 nm to 500 nm, and especially of 50 nm to 200 nm. Thus, advantageous electrical contacting of the active layer 5 and effective introduction of the electrically nonconductive structures U according to the invention are achieved.

The area of the multilayer film M according to the invention can vary widely and thus be adapted to the requirements of the individual case. The area is, for example, from 100 cm² to 20 m². Preferably, the multilayer film M has an area from 400 cm² to 6 m², as is customary for the production of vehicle glazings and of structural and architectural glazings.

The (line) width of the structures U can, for example, be less than or equal to 500 μm. In a preferred embodiment of the invention, the line width is from 10 μm to 150 μm, particularly preferably from 20 μm to 50 μm, for example, from 30 μm to 40 μm. In this range for the width of the structures U, particularly good results are obtained. On the one hand, the electrically nonconductive structure U is wide enough to result in an effective interruption of the electrically conductive layer 4 or 6. On the other, the structure width is advantageously low in order to be only barely visible to an observer. Structuring lines with these low widths can be obtained with mechanical processing methods as well as by laser radiation (laser ablation or laser vaporization). Suitable methods for producing the structuring are described, for example, in WO 2014/072 137 A1.

The system can readily be used in vehicles or buildings.

As a result of the invention, it is now possible to protect individuals from glare from solar radiation. The region of shading can be determined individually. In addition, total shading can optionally also be realized. Different degrees of transparency can readily be provided by controlling the voltage. It is also possible to extend the shading over time, similar to dimming, such that the eyes can more easily get used to the change in brightness.

By means of the sensors 31 . . . 36, intelligent control can be achieved based on different data. Thus, for example, the date and time as well as the actual position data of a satellite navigation system, such as Glonass, GPS, Copernicus, can be used in conjunction with directional data (compass, derived from position data change, driving dynamics sensors) to determine the position of the sun relative to a multilayer film M or a composite glass pane 10. From this, a number of fields for shading can be determined.

In addition, a seat occupied sensor can be used to switch the shading ON/OFF.

Furthermore, an ambient light sensor can be used to control the intensity of the shading and/or to deactivate/activate the shading.

Based on the current driving dynamics values, adaptive adjustment can also be provided with regard to anticipated changes in the position of the sun relative to the multilayer film M or a composite glass pane 10.

In one embodiment of the invention, the system has at least one second sensor 31 . . . 36, which is selected from a group comprising: a position sensor for satellite-based navigation, a position sensor with electric compass, a driving dynamics sensor. This is particularly advantageous in the case of a multilayer film or a composite glass pane (10) in a vehicle and, in particular, in a roof panel.

In this embodiment of the invention, the data of position sensors 31, such as data of a GPS or comparable satellite and a device and/or an electric compass, can be used to determine the position of the multilayer film M relative to solar radiation. Then, one or a plurality of fields A1 . . . D4 that provide shading relative to a seat can, for example, be selectively controlled.

Alternatively, or additionally, the data of a driving dynamics sensor, such as steering angle, inclinometer, driving speed, can be used to determine the current or soon-to-be-reached position of the multilayer film M relative to solar radiation. Then, one or a plurality of fields A1 . . . D4 that provide shading relative to a seat can, for example, be selectively controlled.

In another embodiment, the system has at least one position sensor for satellite-based navigation and/or a position sensor with electric compass and, additionally, at least one driving dynamics sensor.

The invention further includes a method for controlling a system according to the invention, wherein the values of the second sensor (31 . . . 36) are evaluated and the shading of the multilayer film (M) is controlled as a function of the expected change in the position of the sun.

Each active layer requires a certain switching time to change its optical properties. In the case of rapid changes in position, for example, in a vehicle and in particular with use of the system for controlling a roof panel according to the invention, it is possible for the driver or other occupants to be briefly blinded, which entails a safety risk and a loss of comfort.

Through evaluation of the data of the second sensor, an advance prognosis can be established and the shading in the multilayer film can be initiated earlier. Thus, the multilayer film can provide its desired shading properties earlier and the effects of glare are minimized.

Without loss of generality, it is, of course, possible to use the shading for other purposes. Thus, for example, the shading could be used to display symbols or text. Thus, for example, a switching sensor provided in the multilayer film M or in the composite glass pane 10 can be selectively displayed.

### LIST OF REFERENCE CHARACTERS

1 glass pane
2 thermoplastic connecting film
3 carrier layer
4 electrically conductive layer
5 electrically active layer
6 electrically conductive layer
7 carrier layer
8 thermoplastic connecting film
9 glass pane
10 composite glass pane
20 controller
21 x-control
22 y-control
31 position sensor (GPS, compass)
32 seat occupied sensor, seat position sensor
33 intensity sensor, brightness sensor
34 driving dynamics sensor (speed, steering wheel angle)
36 camera
37 manual controller (smartphone, operating device)
M multilayer film
U structure, structuring
FR direction of travel

1. Intelligent transmittance control system, comprising
a multilayer film having a plurality of electrically controllable fields, wherein by means of a control, optical properties of the plurality of electrically controllable fields are influenced, a controller, and at least one sensor,
wherein the multilayer film comprises at least one first structured electrically conductive layer and one second structured electrically conductive layer, wherein an electrically active layer is arranged between the first structured electrically conductive layer and the second structured electrically conductive layer, wherein a structuring of the first electrically conductive layer has an angle of more than 0° relative to a structuring of the second electrically conductive layer, wherein by overlapping the structures of the first electrically conductive layer and the structures of the second electrically conductive layer, the plurality of electrically controllable fields are created,
wherein the controller is adapted to control, as a function of the sensor, one or a plurality of strips of the first electrically conductive layer formed by structures and one or a plurality of strips of the second electrically conductive layer formed by structures such that the optical properties of one or a plurality of electrically controllable fields are selectively influenced,
wherein the system includes at least one sensor selected from a group comprising a seat occupied sensor, a seat position sensor, a camera, a brightness sensor and at least one second sensor selected from a group comprising a position sensor for satellite-based navigation, a position sensor with an electric compass, a driving dynamics sensor.

2. The system according to claim 1, wherein the first structured electrically conductive layer and/or the second structured electrically conductive layer comprises indium tin oxide, ferroelectrics, cholesteric liquid crystal.

3. The system according to claim 1, wherein the system includes
at least one sensor selected from a group comprising a seat occupied sensor, a seat position sensor, a camera, a brightness sensor,
at least one second sensor selected from a group comprising a position sensor with satellite-based navigation, a position sensor with an electric compass, and
additionally, at least one driving dynamics sensor.

4. The system according to claim 1, wherein the structuring of the first electrically conductive layer has an angle of roughly 90° relative to the structuring of the second electrically conductive layer.

5. The system according to claim 1, wherein the multilayer film is part a composite glass pane.

6. The system according to claim 5, wherein the composite glass pane is part of a vehicle glazing.

7. Method for controlling a system according to claim 1, wherein values of the second sensor are evaluated and a shading of the multilayer film is controlled as a function of the expected change in the position of the sun.

8. A method comprising utilizing a system according to claim 7 in a vehicle or in a building.

9. The system according to claim 6, wherein the vehicle glazing is a roof panel of a vehicle.

10. The method according to claim 8, wherein the system is a roof glazing.
